(19) United States
(12) Patent Application Publication
(10) Pub. No.: US 2016/0275606 A1
(43) Pub. Date: Sep. 22, 2016

(54) SYSTEM TO CONFIGURE AND MANAGE MULTIPLE GATEWAY CONNECTIONS IN A NETWORK

(71) Applicant: BANK OF AMERICA CORPORATION, CHARLOTTE, NC (US)

(72) Inventors: Srinivasa Rao Aravala, Visakhapatnam (IN); Rehman Ahmed Khan, Windsor, NJ (US)

(21) Appl. No.: 14/658,392

(22) Filed: Mar. 16, 2015

(51) Int. Cl. G06Q 40/04; H04L 29/08

(52) U.S. Cl. CPC G06Q 40/04; H04L 67/148

(57) ABSTRACT

Embodiments of the invention are directed to systems, methods, and computer program products for configuring and managing multiple gateway connections in a network. The system is configured to receive, using an Enterprise Messaging System (EMS) gateway, an order from one or more clients using a distributed network of servers, wherein the order comprises a Financial Information eXchange (FIX) protocol, wherein the FIX protocol comprises one or more fields, wherein each of the one or more fields comprises a tag value indicating a meaning of the field; validate the order received from the one or more clients using a central FIX engine validator; transform the order received from the one or more clients into one or more corresponding actions to be executed with the financial market; and transmit, using a FIX gateway connection, the transformed order to the financial market; and execute the corresponding action with the financial market.

### FIELD

In general, embodiments of the invention relate to configuring a financial information exchange (FIX) gateway, in particular, embodiments of the invention is directed to a system for configuring and managing multiple FIX gateway connections.

### BACKGROUND

Financial Information eXchange (FIX) protocol is an electronic protocol for international real-time exchange of information related to the securities transactions and markets. In this regard, the FIX protocol is used to manage the delivery of trading applications for optimized trading and low latency. The transmission control protocol/internet protocol (TCP/IP) used in the implementation of the FIX gateway is a point to point data link protocol used to establish a direct connection between two nodes.

There is a need for a system to configure and manage multiple FIX gateway connections for trading in the marketplace.

### BRIEF SUMMARY

Embodiments of the present invention address the above needs and/or achieve other advantages by providing apparatuses (e.g., a system, computer program product, and/or other device) and methods for configuring and managing multiple gateway connections in a network whereby one or more clients may connect to a FIX gateway connection using concurrently.

In one aspect, the system comprises at least one non-transitory storage device; at least one processor; and at least one module stored in said storage device and comprising instruction code that is executable by the at least one processor and configured to cause said at least one processor to: receive, using an Enterprise Messaging System (EMS) gateway, an order from one or more clients using a distributed network of servers, wherein the order comprises a FIX protocol enabling the one or more clients to communicate with a financial market, wherein the FIX protocol comprises one or more fields, wherein each of the one or more fields comprises an associated tag value indicating a meaning of the field; validate the order received from the one or more clients using a central FIX engine validator, wherein validating further comprises: assigning each tag value associated with each field of the FIX protocol a corresponding action to be executed with the financial market, wherein the corresponding action comprises one or more financial market transactions; and maintaining each tag value for consistent execution of the corresponding action; transform the order received from the one or more clients into one or more corresponding actions to be executed with the financial market based on at least validating the order received from the one or more clients, wherein transforming further comprises converting the order from the FIX protocol to one or more financial market specific instructions to execute the order; and transmit, using a FIX gateway connection, the transformed order to an electronic order processing system associated with the financial market, so that the corresponding action associated with the order can be executed by the financial market.

In some embodiments, the module is further configured to cause a processor to: establish a secure connection with a FIX engine server associated with the client to receive the order; receive the order from a client; validate the order received from the client using the central FIX engine validator; and place the received order in an EMS incoming message queue to be executed by the financial market, wherein the EMS incoming message queue comprises data linking the client associated with the order with a position of the order placed in the EMS incoming queue.

In some embodiments, the module is further configured to cause a processor to: establish a secure connection with the order processing system associated with the financial market using a FIX gateway connection, wherein the FIX gateway connection is a transmission control protocol/internet protocol (TCP/IP) based connection; receive a request from the FIX gateway connection to retrieve the validated order from the EMS incoming message queue; transform the validated order into one or more corresponding actions to be executed with the financial market; and transmit the transformed order, via the FIX gateway connection, to the financial market to be executed.

In some embodiments, the module is further configured to cause a processor to: receive, via the FIX gateway connection, a response from the financial market based on at least executing the order received from the client, wherein the response comprises at least a confirmation of the execution; place the response received from the financial market in an EMS outgoing message queue, wherein the EMS outgoing message queue comprises the data linking the client associated with the order with the position of the response to the order placed in the EMS outgoing queue; and transmit the received response to the corresponding client based on at least the data linking the client associated with the order with the position of the response to the order placed in the EMS outgoing queue.

In some embodiments, the module is further configured to cause a processor to: enable the client to manipulate the order at the EMS gateway level prior to the transformation of the order into one or more corresponding actions to be executed with the financial market.

In some embodiments, the module is further configured to cause a processor to: maintain a data-wise incremental log file comprising one or more orders received from the one or more clients.

In some embodiments, the module is further configured to cause a processor to: enable the central FIX engine validator to receive an order from a client in an ad-hoc manner to be added to an Enterprise Messaging System (EMS) message queue for execution at the financial market.

In another aspect, a computer program product for configuring and managing multiple gateway connections in a network whereby one or more clients may connect to a FIX gateway connection using concurrently is presented. The computer program product comprises a non-transitory computer-readable medium comprising code causing a first apparatus to receive, using an Enterprise Messaging System (EMS) gateway, an order from one or more clients using a distributed network of servers, wherein the order comprises a FIX protocol enabling the one or more clients to communicate with a financial market, wherein the FIX protocol comprises one or more fields, wherein each of the one or more fields comprises an associated tag value indicating a meaning of the field; validate the order received from the one or more clients using a central FIX engine validator, wherein validating further comprises: assigning each tag value associated with each field of the FIX protocol a corresponding action to be executed with the financial market, wherein the corresponding action comprises one or more financial market transactions; and maintaining each tag value for consistent execution of the corresponding action; transform the order received from the one or more clients into one or more corresponding actions to be executed with the financial market based on at least validating the order received from the one or more clients, wherein transforming further comprises converting the order from the FIX protocol to one or more financial market specific instructions to execute the order; and transmit, using a FIX gateway connection, the transformed order to an electronic order processing system associated with the financial market, so that the corresponding action associated with the order can be executed by the financial market.

In yet another aspect, a computer implemented method for configuring and managing multiple gateway connections in a network whereby one or more clients may connect to a FIX gateway connection using concurrently is presented. The computer implemented method comprises: receiving, using an Enterprise Messaging System (EMS) gateway, an order from one or more clients using a distributed network of servers, wherein the order comprises a FIX protocol enabling the one or more clients to communicate with a financial market, wherein the FIX protocol comprises one or more fields, wherein each of the one or more fields comprises an associated tag value indicating a meaning of the field; validating, using a computing device processor, the order received from the one or more clients using a central FIX engine validator, wherein validating further comprises: assigning each tag value associated with each field of the FIX protocol a corresponding action to be executed with the financial market, wherein the corresponding action comprises one or more financial market transactions; and maintaining each tag value for consistent execution of the corresponding action; transforming, using a computing device processor, the order received from the one or more clients into one or more corresponding actions to be executed with the financial market based on at least validating the order received from the one or more clients, wherein transforming further comprises converting the order from the FIX protocol to one or more financial market specific instructions to execute the order; and transmitting, using a FIX gateway connection, the transformed order to an electronic order processing system associated with the financial market, so that the corresponding action associated with the order can be executed by the financial market.

### BRIEF DESCRIPTION OF THE DRAWINGS

Having thus described embodiments of the invention in general terms, reference will be made to the accompanying drawings, where:

FIG. 1 illustrates a high level process flow for facilitating the execution of an order from multiple clients, in accordance with embodiments of the present invention.

FIG. 2 illustrates a process flow for implementing an EMS layer over the point-to-point (TCP/IP) based FIX gateway connection, in accordance with embodiments of the present invention.

FIG. 3 illustrates a process flow for executing an order in a financial market, in accordance with embodiments of the present invention.

FIG. 4 illustrates a process flow for receiving a response from the financial market, in accordance with embodiments of the present invention.

FIG. 5A illustrates an exemplary embodiment for the gateway architecture implementing a single EMS incoming queue and a single EMS outgoing queue, in accordance with embodiments of the present invention.

FIG. 5B illustrates an exemplary embodiment for the gateway architecture implementing a single EMS incoming queue and a multiple EMS outgoing queue, in accordance with embodiments of the present invention.

FIG. 6 presents an exemplary block diagram of the system environment 600 for implementing the process flows described herein in accordance with embodiments of the present invention.

### DETAILED DESCRIPTION OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Financial Information eXchange (FIX) protocol is a self-describing, series of messaging specifications used in trade communications, which is fundamental in facilitating many of the electronic trading trends that have emerged over the past decade. FIX has now become the standard electronic protocol for pre-trade communications and trade execution. Typically, trading orders received from clients are received in the FIX format and are routed to a financial market, such as a financial market/exchange (e.g. NASDAQ, NYSE, etc.) for execution. These orders are received through a FIX gateway connection governed by transmission control protocol/internet protocol (TCP/IP) providing high speed connectivity solution for order flow and market data.

Clients may connect to a financial market, such as a financial market via a FIX gateway connection for real-time exchange of information related to the securities transactions and markets. Typically, a FIX gateway is a message routing service using the FIX protocol, combining the benefits of a hub with the advantages of a direct connection. In this way, clients may be provided with a single FIX connection to multiple global liquidity pools to maximize trading efficiency by providing a neutral service with a flexible open architecture. Because the FIX gateway is effectively an invisible hub, it behaves as an end-to-end solution that enables the client to view the real-time status of the information exchanged with financial markets.

While the exchange of information between the clients and the market conform to the FIX protocol, each client may implement a client specific FIX protocol translation to interpret the information exchanged. In this regard, the orders may be internally processed by each client using a client-specific messaging standard and converted into the FIX protocol prior to being transmitted to the financial market via the FIX gateway. Similarly, the clients may receive a response conforming to the FIX protocol from the financial market and convert the response into a client-specific messaging standard for internal processing.

Although the FIX gateway connection offers one single point of connection to connect the client to their choice of liquidity pool, these connections are typically point-to-point connections, when once configured, do not allow for dynamic client configuration and management. In this regard, a FIX gateway connection may include multiple FIX sessions pre-configured to enable a client to exchange information related to securities transactions with a financial market using all available FIX sessions. In doing so, the FIX gateway connection does not allow for additional clients to be connected to the pre-configured FIX gateway connection. In another embodiment, a FIX gateway connection may include multiple FIX sessions pre-configured to host multiple clients to enable each client to connect to the financial market via multiple pre-configured FIX sessions. In doing so, any information received from the financial market in response to information received from each client may be routed to a client different from the client who initiated the information exchange. Furthermore, trading applications that use FIX protocol to serve market participants are generally complicated enterprise applications. Apart from being expensive and time consuming to implement, they require constant maintenance and enhancements as business requirements change with market development, regulations, and other forces affecting the trading industry. In this regard, maintaining the FIX gateway connection individually for multiple clients increases the number of issues encountered and expense incurred.

The present invention provides the functional benefit of establishing multiple gateway connections by implementing an Enterprise Messaging System (EMS) layer over the point-to-point (TCP/IP) based FIX gateway connection to enable multiple clients to communicate in real-time, with a financial market. In this way, the multiple FIX gateway connections may be maintained by a central third party entity instead of having each client managing multiple aspects of the gateway such as logging, acknowledgement, heartbeat, or the like. Further, the present invention implements a round robin processing schedule to conduct information exchange between the financial market and each client to ensure proper routing of information. Additionally, the implementation discussed herein provides fewer connectivity and maintenance issues, thereby enabling clients to exchange information with a financial market more efficiently. Also, the present invention provides the functional benefit of enabling the client to exchange information with the market at any time, providing continuous access and availability of the gateway connection.

As used herein, a “financial market” may refer to a market in which individuals and entities may trade financial securities, commodities, and other fungible items of value. Securities may include stocks and bonds, and commodities may include precious metals or agricultural goods. As used herein, a “market” may refer to an organization that facilitates the trade in financial securities, e.g., a stock exchange or commodity exchange. In some embodiments, a financial market may be a physical location (e.g. New York Stock Exchange (NYSE), Bombay Stock Exchange (BSE), or the like), or an electronic system (e.g., National Association of Securities Dealers Automated Quotation System (NASDAQ)). Typically, a financial market includes an Order Management System (OMS) for order entry and processing. The order management system may be responsible for translating the orders received from clients in FIX messages into an internal language capable of being processed at the financial market. Additionally, the OMS may be responsible for translating the internally processed information into FIX messages to be transmitted back to the client. For purposes of clarity, it should be understood that any reference made to the financial market takes the associated order management system into account for the description herein.

As used herein, a “client” may refer to an investment bank, mutual funds, money managers, investment firms, and in general, market participants, investment managers, stock brokers, or the like involved in real-time exchange of information related to securities, transactions, and financial market. In one aspect, a client may refer to a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the client may allow a user to establish an account with the client. An “account” may be the relationship that the user has with the client. Examples of accounts include a deposit account, such as a transactional account (e.g. a banking account), a savings account, an investment account, a money market account, a time deposit, a demand deposit, a pre-paid account, a credit account, a non-monetary user profile that includes only personal information associated with the user, or the like. The account is associated with and/or maintained by a client. In other embodiments, a “client” may not be a financial institution. For purposes of the invention, the client may be the user of the system.

As used herein, an “order” may refer to an instruction to execute one or more actions (e.g., buying, selling, or the like) on a financial market such as a financial market, bond market, commodity market, financial derivative market, or the like. These instructions may be sent to either a broker or directly to a trading venue via direct market access. In some embodiments, an order may include, but is not limited to, a market order, a limit order, a day order, a conditional order, a discretionary order, or the like.

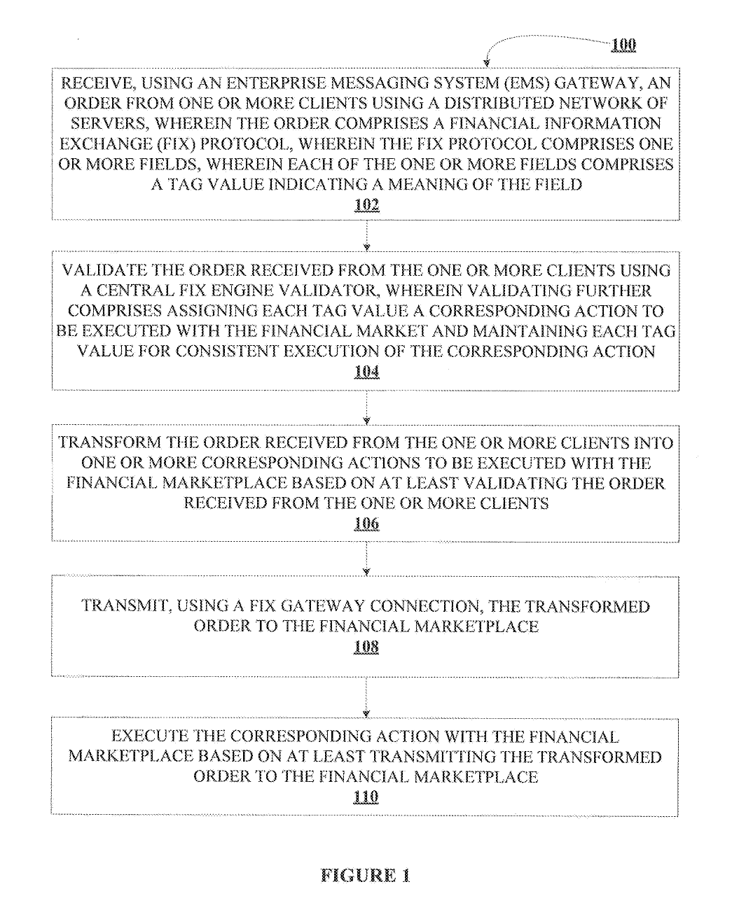

FIG. 1 illustrates a high level process flow for facilitating the execution of an order from multiple clients 100. As shown in block 102, the process flow includes receiving, using an Enterprise Messaging System (EMS) gateway, an order from one or more clients using a distributed network of servers, wherein the order comprises a Financial Information eXchange (FIX) protocol. The FIX protocol comprises a series of messaging specifications to standardize and streamline electronic communications in the financial securities industry. In one aspect, the FIX protocol defines a set of fields such as a header, a checksum, message type, or the like to constitute a particular message. In this regard, each of the one or more fields includes a tag value indicating a meaning of the field. The tag value is typically an array of bytes that hold a specific meaning for the particular tag. In one aspect, the specific meaning may include an action to be performed at the financial market.

EMS is a set of published enterprise-wide standards that allow organizations to send semantically precise messages between applications and systems throughout the organization. In one aspect, the enterprise messaging enables loosely coupled asynchronous messages to be sent by one program and stored in a message queue until the receiving program is able to process it according to a predefined rationale/order.

In response, the process flow includes validating the order received from the one or more clients using a central FIX engine validator, wherein validating further comprises assigning each tag value a corresponding action to be executed with the financial market and maintaining each tag value for consistent execution of the corresponding action, as shown in block 104. Typically, message validation ensures that the orders received conform to protocol standards and directs connections according to the client. Each order received using the FIX protocol typically includes a header that defines the type of the enclosed message body and concludes with a trailer that contains validation information such as a checksum. In some embodiments, the FIX engine validator may validate the received order at a FIX session level. In this regard, the FIX engine validator may determine whether the received order conforms to the FIX protocol prior to transmitting the order to be executed at the financial market.

In some embodiments, the central FIX engine validator receives one or more orders from the one or more clients in a round robin processing schedule to conduct information exchange between the financial market and each client. In one aspect, the one or more orders are received from the one or more clients using an EMS messaging system and placed in a messaging queue to be retrieved and processed by the financial market based on a predetermined order.

In response to validating the order, the process flow includes transforming the order received from the one or more clients into one or more corresponding actions to be executed with the financial market, as shown in block 106. In one aspect, the corresponding actions may include, but are not limited to, placing an order to buy, placing an order to sell, placing an order to position a share in a watch-list, or any possible financial market actions. In this regard, the system may be configured to determine the corresponding action based on each field of the FIX message corresponding to the received order. In response to transforming the order, the process flow includes transmitting, using a FIX gateway connection, the transformed order to the financial market, as shown in block 108. In this regard, the system may be configured to establish a connection between the one or more clients and the financial market using any of the one or more available FIX sessions associated with the FIX gateway.

In response to transmitting the transformed offer, the process flow includes executing the corresponding action associated with the transformed order with the financial market, as shown in block 110. In some embodiments, executing the corresponding action further comprises receiving an execution report associated with the action. In one aspect, the execution report may provide information associated with the status of the order placed. For example, the status may be pending, accepted, rejected, partial, acknowledgement, or the like.

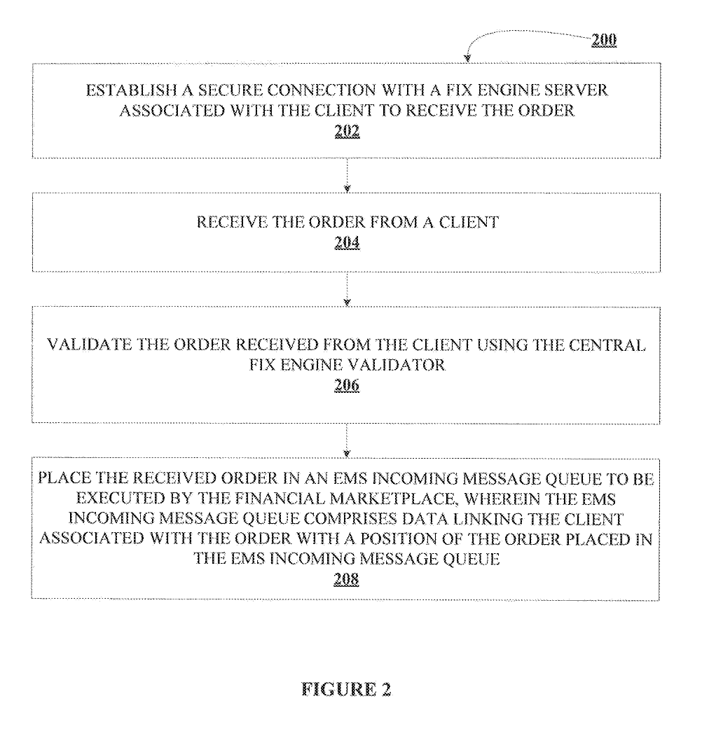

FIG. 2 illustrates a process flow for implementing an EMS layer over the point-to-point (TCP/IP) based FIX gateway connection 200. As shown in block 202, the process flow includes establishing a secure connection with a FIX engine server associated with the client to receive the order. Typically, the FIX engine server associated with the client processes the order to be placed by the client internally and translates the order to conform to the FIX protocol to be executed at the financial market. In this regard, the system may be configured to implement an EMS messaging layer over the point-to-point (TCP/IP) based FIX gateway connection to establish a secure connection capable of receiving one or more orders from multiple clients concurrently.

In response to establishing a secure connection, the process flow includes receiving an order from the client, as shown in block 204. As shown in block 206, in response to receiving the order, the process flow includes validating the order received from the client using the central FIX engine validator, as described earlier. In response to validating the order, the process flow includes placing the received order in an EMS incoming message queue to be executed by the financial market place, wherein the EMS incoming message queue comprises data linking the client associated with the order with a position of the order placed in the EMS incoming queue, as shown in block 208. In some embodiments, the system may be configured to place the order received from the client in the message queue and does not need to wait for a response to continue receiving orders from other clients. In doing so, the system may be configured to receive one or more orders from one or more clients, thereby configuring a multi-gateway connection between the clients and the financial market. In this way, the EMS message queue is configured to be a queue of orders waiting to be processed by the financial market based on a predetermined rationale.

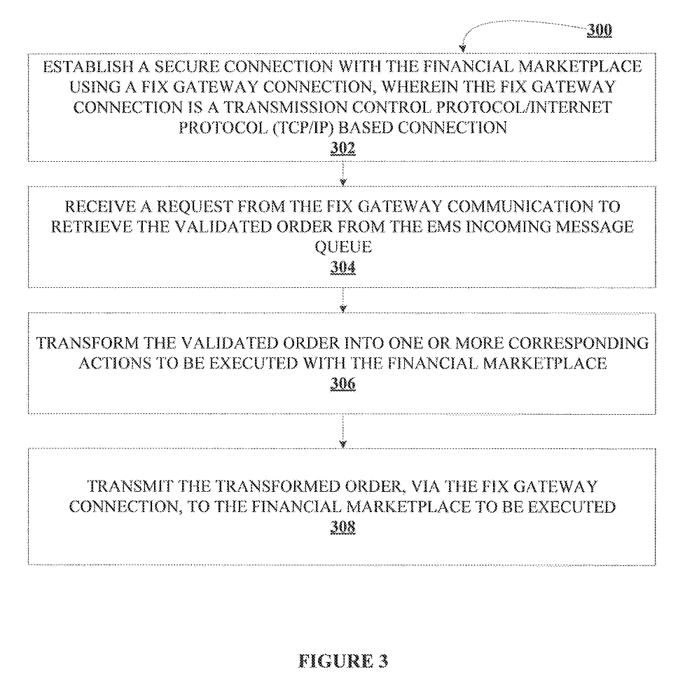

FIG. 3 illustrates a process flow for executing an order in a financial market 300. As shown in block 302, the process flow includes establishing a secure connection with the financial market using a FIX gateway connection, wherein the FIX gateway connection is a transmission control protocol/internet protocol (TCP/IP) based connection. In this regard, the system may be configured to establish a secure connection between the overlaid EMS layer and the financial market. In response to establishing the secure connection, the process flow includes receiving a request from the FIX gateway connection to retrieve the validated order from the EMS incoming message queue, as shown in block 304. In this regard, the system may be configured to establish a rationale or a queuing theory model to provide at least one of the one or more orders in the EMS incoming message queue to the financial market. In one aspect, the rationale may include assigning a priority to each order received from the one or more clients. In another aspect, the rationale may include a first-in-first-out order of processing. In yet another aspect, the rationale may include a first-in-last-out order of processing.

In response to receiving the request, the process flow includes transforming the validated order into one or more corresponding actions to be executed with the financial market, as shown in block 306. In response to transforming the data, the process flow includes transmitting the transformed order, via the FIX gateway connection, to the financial market to be executed, as shown in block 308. In some embodiments, the system may be configured to push the transformed order and transmit the transformed order to be executed in the financial market without the need for a request to be received from the FIX gateway connection. In this regard, the system may be configured to transmit the transformed order based on a predetermined schedule.

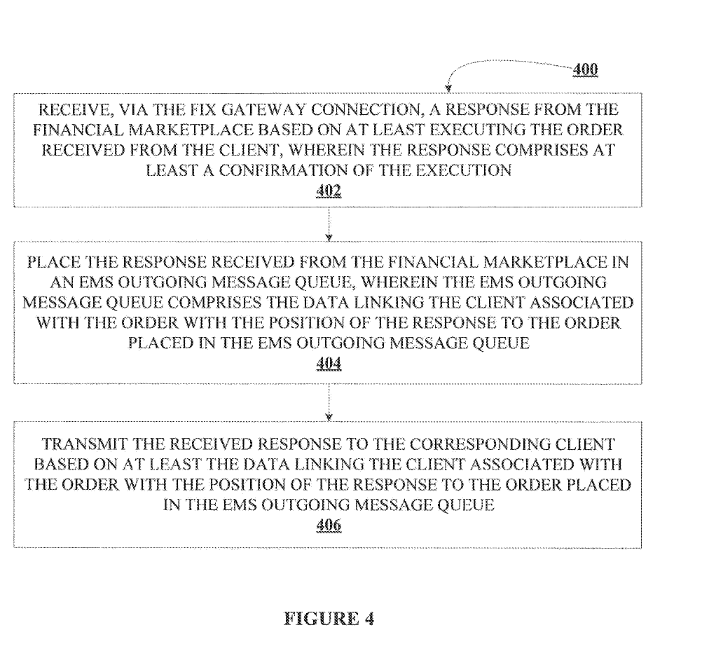

FIG. 4 illustrates a process flow for receiving a response from the financial market 400. As shown in block 402, the process flow includes receiving, via the FIX gateway connection, a response from the financial market based on at least executing the order received from the client, wherein the response comprises at least a confirmation of the execution. In response to receiving, the process flow includes placing the response received from the financial market in an EMS outgoing queue, wherein the EMS outgoing message queue comprises data linking the client associated with the order with the position of the response to the order placed in the EMS outgoing queue, as shown in block 404. In some embodiments, the response for each executed order is positioned in the sequence in which the order was executed in the financial market. In another embodiment, the response for each order is positioned in the same sequence in which the orders were initially placed in the EMS incoming queue.

In response to placing the response in the EMS outgoing queue, the process flow includes transmitting the received response to the corresponding client based on at least the data linking the client associated with the order with the position of the response to the order placed in the EMS outgoing queue, as show in block 406.

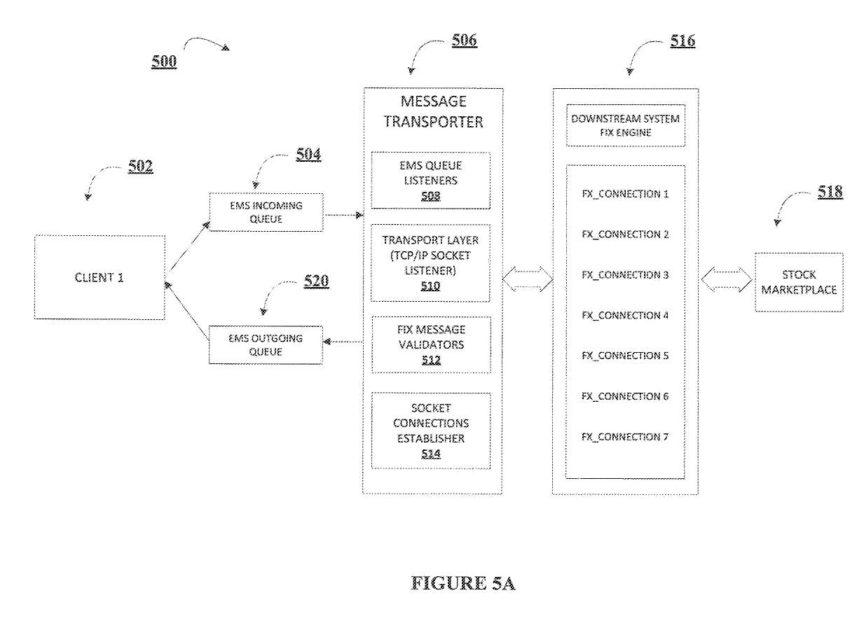

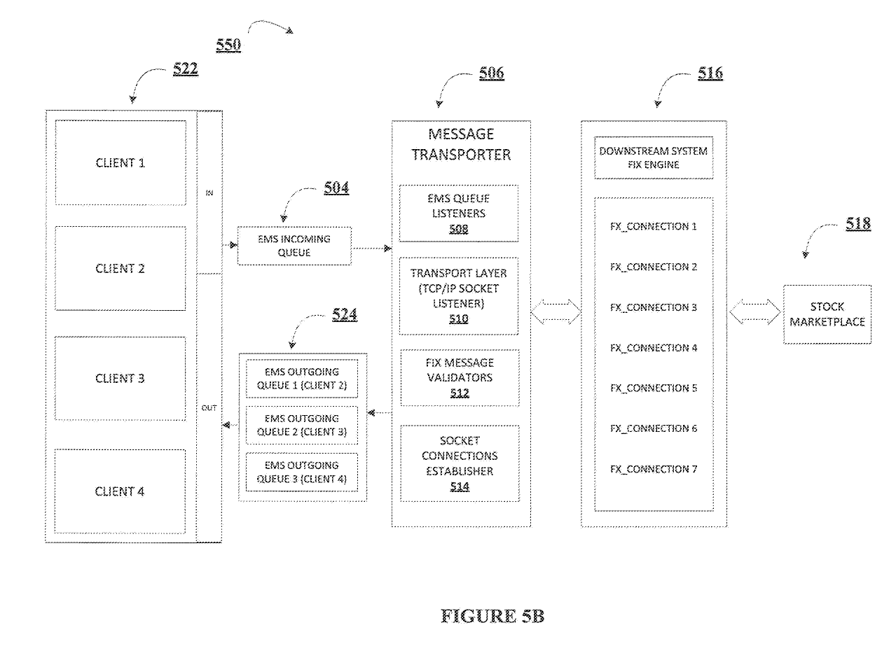

FIG. 5A illustrates an exemplary embodiment for the gateway architecture implementing a single EMS incoming queue and a single EMS outgoing queue 500. As shown, the gateway architecture includes a client 502, an EMS incoming queue 504, an EMS outgoing queue 520, a message transporter 506, a downstream system FIX engine 516, and a financial market 518. Further, the message transporter 506 further includes an EMS queue listener 508, a transport layer (TCP/IP socket listener) 510, FIX message validators 512, and a socket connection establisher 514. As shown in FIG. 5A, each order placed by the client 512 is placed in the EMS incoming queue 504. The order received from the client is typically in the FIX messaging format. In response, the message transporter 506 “listens” to any changes in the content of the queue using the EMS queue listener 508 to determine whether an order needs to be placed. The FIX message validators 512 determine that the received order conforms to the FIX protocol with valid tag values for each field in the FIX message. The socket connection establisher 514 works in tandem with the transport layer (TCP/IP socket listener) 510 to establish a connection with the downstream system FIX engine 516 via a FIX gateway.

As shown in FIG. 5A, the downstream system FIX engine 516 enables the system to establish a connection between the EMS layer and the financial market for exchange of information using a TCP/IP connection. In one aspect, the downstream system FIX engine 516 may enable the system to establish multiple FIX sessions to exchange information. The architecture may be configured in such a way that in response to the execution of an order, the downstream system FIX engine 516 and in-turn the message transporter 506 may receive a response from the financial market (e.g. execution report) to be place in the EMS outgoing queue. In response, the system may be configured to provide the response to the client. In this regard, the client may be configured to implement systems to “listen” to changes in the EMS outgoing queue based on at least data linking the client with a position of the response to the order placed by the client in the EMS outgoing queue. In one aspect, the client system FIX engine (not shown) may be configured to both “listen” to the changes in the EMS outgoing queue, and in response to listening, translate the FIX message into an internal client-specific language for processing.

In some embodiments, the system may be configured to present each client with a personalized EMS incoming queue and a personalized EMS outgoing queue to place an order with the financial market and receive the corresponding response.

FIG. 5B illustrates an exemplary embodiment for the gateway architecture implementing a single EMS incoming queue and a multiple EMS outgoing queue 550. As shown, the gateway architecture includes multiple clients 522, a single EMS incoming queue 504, and multiple EMS outgoing queues 524. In some embodiments, the system may be configured to receive the response from the financial market and place the response in one of the multiple EMS outgoing queues. In response, the system may be configured to enable the client to retrieve the response based on at least data linking the client associated with the order with the position of the response to the order placed in the EMS outgoing queue. In one aspect, the data may include a client identifier. In this way, the one-to-many architecture described in FIG. 5B may enable multiple clients to exchange information with the financial market.

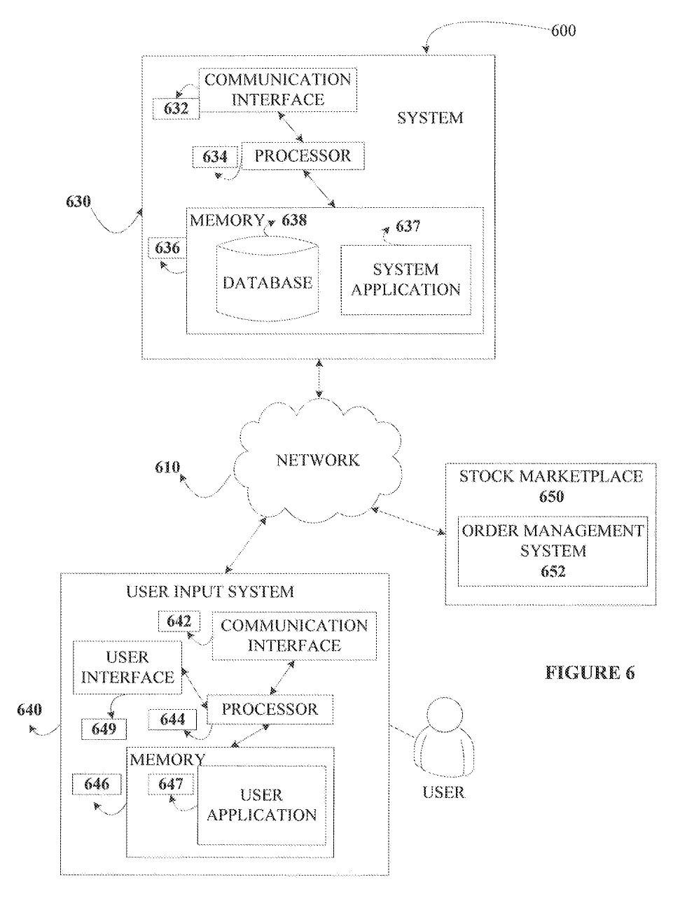

FIG. 6 presents an exemplary block diagram of the system environment 600 for implementing the process flows described herein in accordance with embodiments of the present invention. As illustrated, the system environment 600 includes a network 610, a system 630, and a user input system 640. Also shown in FIG. 6 is a user of the user input system 640. The user input system 640 may be a mobile device or other non-mobile computing device. The user may be a person or a client who uses the user input system 640 to execute a user application 647. The user application 647 may be an application to communicate with the system 630, perform a transaction, input information onto a user interface presented on the user input system 640, or the like. The user application 647 and/or the system application 637 may incorporate one or more parts of any process flow described herein.

As shown in FIG. 6, the system 630, and the user input system 640 are each operatively and selectively connected to the network 610, which may include one or more separate networks. In addition, the network 610 may include a telecommunication network, local area network (LAN), a wide area network (WAN), and/or a global area network (GAN), such as the Internet. It will also be understood that the network 610 may be secure and/or unsecure and may also include wireless and/or wired and/or optical interconnection technology.

The user input system 640 may include any computerized apparatus that can be configured to perform any one or more of the functions of the user input system 640 described and/or contemplated herein. For example, the user may use the user input system 640 to transmit and/or receive information or commands to and from the system 630. In some embodiments, for example, the user input system 640 may include a personal computer system (e.g. a non-mobile or non-portable computing system, or the like), a mobile computing device, a personal digital assistant, a mobile phone, a tablet computing device, a network device, and/or the like. As illustrated in FIG. 6, in accordance with some embodiments of the present invention, the user input system 640 includes a communication interface 642, a processor 644, a memory 646 having an user application 647 stored therein, and a user interface 649. In such embodiments, the communication interface 642 is operatively and selectively connected to the processor 644, which is operatively and selectively connected to the user interface 649 and the memory 646. In some embodiments, the user may use the user application 647 to execute processes described with respect to the process flows described herein. Specifically, the user application 647 executes the process flows described herein.

Each communication interface described herein, including the communication interface 642, generally includes hardware, and, in some instances, software, that enables the user input system 640, to transport, send, receive, and/or otherwise communicate information to and/or from the communication interface of one or more other systems on the network 610. For example, the communication interface 642 of the user input system 640 may include a wireless transceiver, modem, server, electrical connection, and/or other electronic device that operatively connects the user input system 640 to another system such as the system 630. The wireless transceiver may include a radio circuit to enable wireless transmission and reception of information. Additionally, the user input system 640 may include a positioning system. The positioning system (e.g. a global positioning system (GPS), a network address (IP address) positioning system, a positioning system based on the nearest cell tower location, or the like) may enable at least the user input system 640 or an external server or computing device in communication with the user input system 640 to determine the location (e.g. location coordinates) of the user input system 640.

Each processor described herein, including the processor 644, generally includes circuitry for implementing the audio, visual, and/or logic functions of the user input system 640. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 647 of the memory 646 of the user input system 640.

Each memory device described herein, including the memory 646 for storing the user application 647 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 6, the memory 646 includes the user application 647. In some embodiments, the user application 647 includes an interface for communicating with, navigating, controlling, configuring, and/or using the user input system 640. In some embodiments, the user application 647 includes computer-executable program code portions for instructing the processor 644 to perform one or more of the functions of the user application 647 described and/or contemplated herein. In some embodiments, the user application 647 may include and/or use one or more network and/or system communication protocols.

Also shown in FIG. 6 is the user interface 649. In some embodiments, the user interface 649 includes one or more output devices, such as a display and/or speaker, for presenting information to the user. In some embodiments, the user interface 349 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user. In some embodiments, the user interface 649 includes the input and display devices of a mobile device, which are operable to receive and display information.

FIG. 6 also illustrates a system 630, in accordance with an embodiment of the present invention. The system 630 may refer to the “apparatus” described herein. The system 630 may include any computerized apparatus that can be configured to perform any one or more of the functions of the system 630 described and/or contemplated herein. In accordance with some embodiments, for example, the system 630 may include a computer network, an engine, a platform, a server, a database system, a front end system, a back end system, a personal computer system, and/or the like. Therefore, the system 630 may be a server managed by the business. The system 630 may be located at the facility associated with the business or remotely from the facility associated with the business. In some embodiments, such as the one illustrated in FIG. 6, the system 630 includes a communication interface 632, a processor 634, and a memory 636, which includes a system application 637 and a structured database 638 stored therein. As shown, the communication interface 632 is operatively and selectively connected to the processor 634, which is operatively and selectively connected to the memory 636.

It will be understood that the system application 637 may be configured to implement any one or more portions of the various user interfaces and/or process flow described herein. The system application 637 may interact with the user application 647. It will also be understood that, in some embodiments, the memory includes other applications. It will also be understood that, in some embodiments, the system application 637 is configured to communicate with the structured database 638, the user input system 640, or the like.

It will be further understood that, in some embodiments, the system application 637 includes computer-executable program code portions for instructing the processor 634 to perform any one or more of the functions of the system application 637 described and/or contemplated herein. In some embodiments, the system application 637 may include and/or use one or more network and/or system communication protocols.

In addition to the system application 637, the memory 636 also includes the structured database 638. As used herein, the structured database 638 may be one or more distinct and/or remote databases. In some embodiments, the structured database 638 is not located within the system and is instead located remotely from the system. In some embodiments, the structured database 638 stores information or data described herein.

It will be understood that the structured database 638 may include any one or more storage devices, including, but not limited to, datastores, databases, and/or any of the other storage devices typically associated with a computer system. It will also be understood that the structured database 638 may store information in any known way, such as, for example, by using one or more computer codes and/or languages, alphanumeric character strings, data sets, figures, tables, charts, links, documents, and/or the like. Further, in some embodiments, the structured database 638 may include information associated with one or more applications, such as, for example, the system application 637. It will also be understood that, in some embodiments, the structured database 638 provides a substantially real-time representation of the information stored therein, so that, for example, when the processor 634 accesses the structured database 638, the information stored therein is current or substantially current.

FIG. 6 also illustrates a financial market 650, in accordance with an embodiment of the present invention. As described herein, the system 630 may be configured to communicate with the financial market 650 and facilitate the exchange of information between the user input system 640 and the financial market 650. In this way, the system 650 may transport messages by implementing the EMS gateway over the point-to-point (TCP/IP) based FIX gateway connection to establish multiple gateways for communication. As shown in FIG. 6, the financial market 650 includes an order management system 652 capable of receiving FIX messages from the user input system 640 via the system 630 and process the FIX message for execution at the financial market 650.

It will be understood that the embodiment of the system environment illustrated in FIG. 6 is exemplary and that other embodiments may vary. As another example, in some embodiments, the system 630 includes more, less, or different components. As another example, in some embodiments, some or all of the portions of the system environment 600 may be combined into a single portion. Likewise, in some embodiments, some or all of the portions of the system 630 may be separated into two or more distinct portions.

In addition, the various portions of the system environment 600 may be maintained for and/or by the same or separate parties. It will also be understood that the system 630 may include and/or implement any embodiment of the present invention described and/or contemplated herein. For example, in some embodiments, the system 630 is configured to implement any one or more of the embodiments of the process flows described and/or contemplated herein in connection any process flow described herein. Additionally, the system 630 or the user input system 640 is configured to initiate presentation of any of the user interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for configuring and managing multiple gateway connections in a network whereby one or more clients may connect to a Financial Information eXchange (FIX) gateway connection concurrently, the system comprising:
at least one non-transitory storage device;
at least one processor; and
at least one module stored in said storage device and comprising instruction code that is executable by the at least one processor and configured to cause said at least one processor to:
receive, using an Enterprise Messaging System (EMS) gateway, an order from one or more clients using a distributed network of servers, wherein the order comprises a FIX protocol enabling the one or more clients to communicate with a financial market, wherein the FIX protocol comprises one or more fields, wherein each of the one or more fields comprises an associated tag value indicating a meaning of the field;
validate the order received from the one or more clients using a central FIX engine validator, wherein validating further comprises:
assigning each tag value associated with each field of the FIX protocol a corresponding action to be executed with the financial market, wherein the corresponding action comprises one or more financial market transactions; and
maintaining each tag value for consistent execution of the corresponding action;
transform the order received from the one or more clients into one or more corresponding actions to be executed with the financial market based on at least validating the order received from the one or more clients, wherein transforming further comprises converting the order from the FIX protocol to one or more financial market specific instructions to execute the order; and
transmit, using a FIX gateway connection, the transformed order to an electronic order processing system associated with the financial market, so that the corresponding action associated with the order can be executed by the financial market.

2. The system of claim 1, wherein the module is further configured to cause a processor to:
establish a secure connection with a FIX engine server associated with the client to receive the order;
receive the order from a client;
validate the order received from the client using the central FIX engine validator; and
place the received order in an EMS incoming message queue to be executed by the financial market, wherein the EMS incoming message queue comprises data linking the client associated with the order with a position of the order placed in the EMS incoming message queue.

3. The system of claim 2, wherein the module is further configured to cause a processor to:
establish a secure connection with the order processing system associated with the financial market using a FIX gateway connection, wherein the FIX gateway connection is a transmission control protocol/internet protocol (TCP/IP) based connection;
receive a request from the FIX gateway connection to retrieve the validated order from the EMS incoming message queue;
transform the validated order into one or more corresponding actions to be executed with the financial market; and
transmit the transformed order, via the FIX gateway connection, to the financial market to be executed.

4. The system of claim 2, wherein the module is further configured to cause a processor to:
receive, via the FIX gateway connection, a response from the financial market based on at least executing the order received from the client, wherein the response comprises at least a confirmation of the execution;
place the response received from the financial market in an EMS outgoing message queue, wherein the EMS outgoing message queue comprises the data linking the client associated with the order with the position of the response to the order placed in the EMS outgoing message queue; and
transmit the received response to the corresponding client based on at least the data linking the client associated with the order with the position of the response to the order placed in the EMS outgoing message queue.

5. The system of claim 1, wherein the module is further configured to cause a processor to:
receive one or more instructions to perform one or more corresponding actions from a client; and
transform the one or more instructions associated with the one or more corresponding actions into FIX protocol prior to transmitting the order to the central FIX engine validator.

6. The system of claim 1, wherein the module is further configured to cause a processor to:
enable the client to manipulate the order at the EMS gateway level prior to the transformation of the order into one or more corresponding actions to be executed with the financial market.

7. The system if claim 1, wherein the module is further configured to cause a processor to:
maintain a data-wise incremental log file comprising one or more orders received from the one or more clients.

8. The system of claim 1, wherein the module is further configured to cause a processor to:
enable the central FIX engine validator to receive an order from a client in an ad-hoc manner to be added to an Enterprise Messaging System (EMS) message queue for execution at the financial market.

9. A computer program product for configuring and managing multiple gateway connections in a network whereby one or more clients may connect to a FIX gateway connection using concurrently, the computer program product comprising a non-transitory computer-readable medium comprising code causing a first apparatus to:
receive, using an Enterprise Messaging System (EMS) gateway, an order from one or more clients using a distributed network of servers, wherein the order comprises a FIX protocol enabling the one or more clients to communicate with a financial market, wherein the FIX protocol comprises one or more fields, wherein each of the one or more fields comprises an associated tag value indicating a meaning of the field;
validate the order received from the one or more clients using a central FIX engine validator, wherein validating further comprises:
assigning each tag value associated with each field of the FIX protocol a corresponding action to be executed with the financial market, wherein the corresponding action comprises one or more financial market transactions; and
maintaining each tag value for consistent execution of the corresponding action;
transform the order received from the one or more clients into one or more corresponding actions to be executed with the financial market based on at least validating the order received from the one or more clients, wherein transforming further comprises converting the order from the FIX protocol to one or more financial market specific instructions to execute the order; and
transmit, using a FIX gateway connection, the transformed order to an electronic order processing system associated with the financial market, so that the corresponding action associated with the order can be executed by the financial market.

10. The computer program product of claim 9, wherein the first apparatus is further configured to cause a processor to:
establish a secure connection with a FIX engine server associated with the client to receive the order;
receive the order from a client;
validate the order received from the client using the central FIX engine validator; and
place the received order in an EMS incoming message queue to be executed by the financial market, wherein the EMS incoming message queue comprises data linking the client associated with the order with a position of the order placed in the EMS incoming message queue.

11. The computer program product of claim 10, wherein the first apparatus is further configured to cause a processor to:
establish a secure connection with the order processing system associated with the financial market using a FIX gateway connection, wherein the FIX gateway connection is a transmission control protocol/internet protocol (TCP/IP) based connection;
receive a request from the FIX gateway connection to retrieve the validated order from the EMS incoming message queue;
transform the validated order into one or more corresponding actions to be executed with the financial market; and
transmit the transformed order, via the FIX gateway connection, to the financial market to be executed.

12. The computer program product of claim 10, wherein the first apparatus is further configured to cause a processor to:
receive, via the FIX gateway connection, a response from the financial market based on at least executing the order received from the client, wherein the response comprises at least a confirmation of the execution;
place the response received from the financial market in an EMS outgoing message queue, wherein the EMS outgoing message queue comprises the data linking the client associated with the order with the position of the response to the order placed in the EMS outgoing message queue; and
transmit the received response to the corresponding client based on at least the data linking the client associated with the order with the position of the response to the order placed in the EMS outgoing message queue.

13. The computer program product of claim 9, wherein the first apparatus is further configured to cause a processor to:
enable the client to manipulate the order at the EMS gateway level prior to the transformation of the order into one or more corresponding actions to be executed with the financial market.

14. A computer implemented method for configuring and managing multiple gateway connections in a network whereby one or more clients may connect to a FIX gateway connection using concurrently, the computer implemented method comprising:
receiving, using an Enterprise Messaging System (EMS) gateway, an order from one or more clients using a distributed network of servers, wherein the order comprises a FIX protocol enabling the one or more clients to communicate with a financial market, wherein the FIX protocol comprises one or more fields, wherein each of the one or more fields comprises an associated tag value indicating a meaning of the field;
validating, using a computing device processor, the order received from the one or more clients using a central FIX engine validator, wherein validating further comprises:
assigning each tag value associated with each field of the FIX protocol a corresponding action to be executed with the financial market, wherein the corresponding action comprises one or more financial market transactions; and
maintaining each tag value for consistent execution of the corresponding action;
transforming, using a computing device processor, the order received from the one or more clients into one or more corresponding actions to be executed with the financial market based on at least validating the order received from the one or more clients, wherein transforming further comprises converting the order from the FIX protocol to one or more financial market specific instructions to execute the order; and
transmitting, using a FIX gateway connection, the transformed order to an electronic order processing system associated with the financial market, so that the corresponding action associated with the order can be executed by the financial market.

15. The method of claim 14, wherein the computer implemented method further comprises:
establishing a secure connection with a FIX engine server associated with the client to receive the order;
receiving the order from a client;
validating the order received from the client using the central FIX engine validator; and
placing the received order in an EMS incoming message queue to be executed by the financial market, wherein the EMS incoming message queue comprises data linking the client associated with the order with a position of the order placed in the EMS incoming message queue.

16. The method of claim 15, wherein the computer implemented method further comprises:
establishing a secure connection with the order processing system associated with the financial market using a FIX gateway connection, wherein the FIX gateway connection is a transmission control protocol/internet protocol (TCP/IP) based connection;
receiving a request from the FIX gateway connection to retrieve the validated order from the EMS incoming message queue;
transforming the validated order into one or more corresponding actions to be executed with the financial market; and
transmitting the transformed order, via the FIX gateway connection, to the financial market to be executed.

17. The method of claim 15, wherein the computer implemented method further comprises:
receiving, via the FIX gateway connection, a response from the financial market based on at least executing the order received from the client, wherein the response comprises at least a confirmation of the execution;
placing the response received from the financial market in an EMS outgoing message queue, wherein the EMS outgoing message queue comprises the data linking the client associated with the order with the position of the response to the order placed in the EMS outgoing queue; and
transmitting the received response to the corresponding client based on at least the data linking the client associated with the order with the position of the response to the order placed in the EMS outgoing queue.

18. The method of claim 14, wherein the computer implemented method further comprises:
enabling the client to manipulate the order at the EMS gateway level prior to the transformation of the order into one or more corresponding actions to be executed with the financial market.

19. The method of claim 14, wherein the computer implemented method further comprises:
maintaining a data-wise incremental log file comprising one or more orders received from the one or more clients.

20. The method of claim 14, wherein the computer implemented method further comprises:
enabling the central FIX engine validator to receive an order from a client in an ad-hoc manner to be added to an Enterprise Messaging System (EMS) message queue for execution at the financial market.
